(19) United States
(12) Patent Application Publication
(10) Pub. No.: US 2025/0006957 A1
(43) Pub. Date: Jan. 2, 2025

(54) SYSTEM FOR WASTE HEAT RECOVERY OF FUEL CELL AND VEHICLE

(71) Applicant: BEIJING NATIONAL NEW ENERGY VEHICLE TECHNOLOGY INNOVATION CENTER CO. , LTD., Beijing (CN)

(72) Inventors: Fang FANG, Beijing (CN); Luncheng DUAN, Beijing (CN); Ruijie SUN, Beijing (CN); Chengyin YUAN, Beijing (CN)

(21) Appl. No.: 18/706,119

(22) PCT Filed: Aug. 11, 2022
(86) PCT No.: PCT/CN2022/111837

§ 371 Date: Apr. 30, 2024

(30) Foreign Application Priority Data
Dec. 23, 2021 (CN) 202111589714.7

(51) Int. Cl. H01M 8/04007; B60L 1/00; B60L 50/75; B60L 53/50; B60L 58/33; H01M 8/04029; H01M 8/0432; H01M 8/04746; H01M 16/00

(52) U.S. Cl. CPC H01M 8/04067; B60L 50/75; B60L 58/33; H01M 8/04029; H01M 8/04365; H01M 8/04768; H01M 16/006; B60L 1/20; B60L 53/50; B60L 2210/10; H01M 2250/20; H01M 2250/402

(57) ABSTRACT

The present disclosure relates to the technical field of fuel cells, in particular to a system for heat recovery of a fuel cell and a vehicle. The system comprises a cold source side, a heat source side and a thermoelectric conversion module located between the cold source side and the heat source side. The fuel cell exchanges heat with the heat source side; when the temperature of the fuel cell is greater than a preset value, the thermoelectric conversion module converts heat energy into electric energy; when the temperature of the fuel cell is less than the preset value, the thermoelectric conversion module is reversely electrified to heat the heat source side. According to the present disclosure, the thermoelectric conversion module is used, and low-grade heat energy is directly converted into electric energy by using the Seebeck effect of semiconductor thermoelectric power generation material, so that heat dissipation burden of a heat dissipation system can be relieved, the electric energy can also be reused by other vehicle-mounted electric appliances, the operation efficiency of the system is improved, and the purpose of saving energy is achieved; moreover, an electric pile can be heated in a reverse direction under the electrifying condition, the cold start performance of the system is improved, the fuel cell does not need to be heated by means of a PTC, and the system cost is effectively reduced.

### FIELD OF TECHNOLOGY

The present disclosure relates to the technical field of fuel cells, and specifically relates to a system for waste heat recovery of fuel cell and a vehicle.

### BACKGROUND

The operating temperature of low-temperature proton exchange membrane fuel cells is generally between 70-90° C., and a large amount of heat is generally generated during the operation, and heating power of the fuel cell can be roughly equal to its generation power. In larger power stacks, the heating power can be as high as 100 kW or even higher. At the same time, in order to expand the scope of applications, improve product competitiveness, and meet lower cold start temperature performance requirements, the existing stack system is equipped with electric heating equipment to ensure the low-temperature cold start performance of the stack. However, additional heating equipment will occupy the volume and mass of the system, resulting in a decrease in the volume power density and mass power density of the system. Therefore, on the one hand, from the perspective of heat dissipation, dissipating such a huge amount of heat brings out more stringent requirements for the vehicle cooling system; and from the perspective of vehicle energy utilization, dissipating the heat in vain is a huge waste of energy. On the other hand, solving the cold start problem of the stack without increasing the volume and quality of the system is the key to high-power fuel cell stack systems.

### SUMMARY

The technical problem to be solved by the present disclosure is to provide a device capable of recycling waste heat of a fuel cell and a vehicle.

In order to solve the above technical problems, the technical solution adopted by the present disclosure is:

A system for waste heat recovery of a fuel cell, comprising a cold source side, a heat source side, and a thermoelectric conversion module located between the cold source side and the heat source side;
the fuel cell forms heat exchange with the heat source side;
when temperature of the fuel cell is greater than a preset value, the thermoelectric conversion module converts thermal energy into electrical energy;
when the temperature of the fuel cell is lower than the preset value, the thermoelectric conversion module is reversely electrified to heat the heat source side.

Preferably, the thermoelectric conversion module outputs through a DCDC inverter.

Preferably, the thermoelectric conversion module includes multiple groups of thermoelectric materials connected in series, ends at one side of the thermoelectric materials are connected by conductor to form a PN junction and are in contact with the heat source side, and ends at the other side of the thermoelectric materials are in contact with the cold source side . . .

Preferably, insulators are respectively arranged between the thermoelectric conversion module and the heat source side, and between the thermoelectric conversion module and the cold source side.

In order to solve the above technical problems, another technical solution adopted by the present disclosure is:
A vehicle, comprising a cooler, a fuel cell and the above system for waste heat recovery of a fuel cell;
the cold source side performs heat exchange with the cooler.

Preferably, the cold source side comprises a cold source box and pipelines, the cold source box comprises a cold source fluid inlet and a cold source fluid outlet, and the cold source fluid inlet and the cold source fluid outlet are respectively communicated with the cooler through the pipelines; there is cold source fluid in the cold source box.

Preferably, the fuel cell comprises a cooling flow channel;
the heat source side comprises a heat source box and pipelines, and the heat source box comprises a heat source fluid inlet and a heat source fluid outlet, and the heat source fluid inlet and the heat source fluid outlet communicate with both ends of the cooling flow channel of the fuel cell through the pipelines; there is heat source fluid in the heat source box.

Preferably, the vehicle also comprises a controller, a temperature sensor, a first pump, and a second pump;
the controller is electrically connected to the temperature sensor, the first pump and the second pump;
the temperature sensor is arranged on the fuel cell;
the first pump drives heat exchange between the cold source side and the cooler;
the second pump drives heat exchange between the heat source side and the fuel cell.

Preferably, the vehicle also comprises a storage battery, and the storage battery is electrically connected to the controller, the temperature sensor, the first pump, the second pump, and the thermoelectric conversion module;
the controller controls direction of current between the storage battery and the thermoelectric conversion module.

The beneficial effect of the present disclosure is that by adopting a thermoelectric conversion module and utilizing the Seebeck effect of semiconductor thermoelectric power generation materials to directly convert low-grade thermal energy into electrical energy, it can not only reduce the heat dissipation burden of the heat dissipation system, but also convert low-grade thermal energy into electrical energy, which can be reused by other vehicle-mounted electrical appliances to improve system operating efficiency and achieve energy saving. At the same time, the stack can be heated in reverse under energized conditions to improve the cold start performance of the system. There is no need to heat the fuel cell through PTC, reducing the number of system components and the complexity of the system, effectively reducing the system cost.

### BRIEF DESCRIPTION OF THE DRAWINGS

FIG. 1 is a schematic diagram of the principle of the thermoelectric conversion module of the present application;

FIG. 2 is a schematic structural diagram of a system for waste heat recovery of a fuel cell according to a specific embodiment of the present disclosure.

### REFERENCE NUMBERS

1. cold source box; 11. cold source fluid inlet; 12. cold source fluid outlet; 2. heat source box; 21. heat source fluid inlet; 22. heat source fluid outlet; 3. thermoelectric conversion module; 31. thermoelectric material; 32. insulator; 4. DCDC inverter; 5. output port.

### DESCRIPTION OF THE EMBODIMENTS

In order to describe the technical content, achieved objectives and effects of the present disclosure in detail, the following description will be made in conjunction with the embodiments and the accompanying drawings.

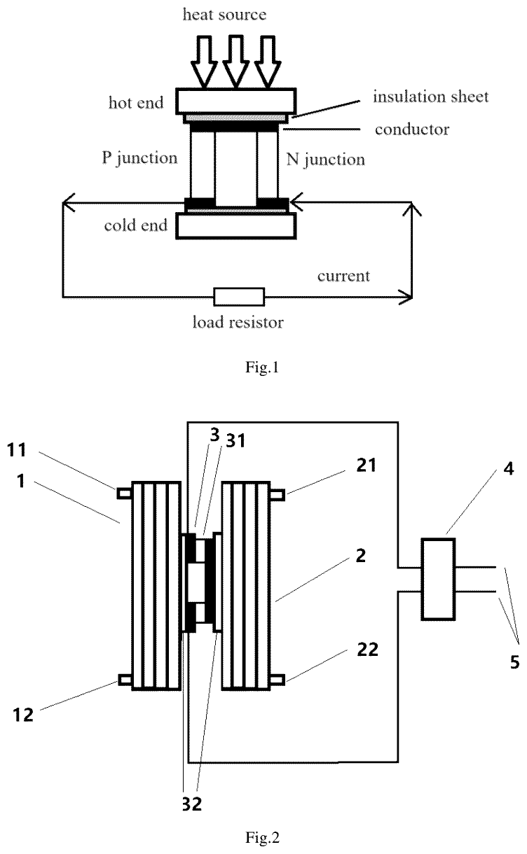

Referring to FIG. 1 and FIG. 2, a system for waste heat recovery of a fuel cell, comprising a cold source side, a heat source side, and a thermoelectric conversion module 3 located between the cold source side and the heat source side;
the fuel cell forms heat exchange with the heat source side;
when temperature of the fuel cell is greater than a preset value, the thermoelectric conversion module 3 converts thermal energy into electrical energy;
when the temperature of the fuel cell is lower than the preset value, the thermoelectric conversion module 3 is reversely electrified to heat the heat source side.

The thermoelectric conversion module 3 outputs through a DCDC inverter 4.

The thermoelectric conversion module 3 includes multiple groups of thermoelectric materials 31 connected in series, ends at one side of the thermoelectric materials 31 are connected by conductor to form a PN junction and are in contact with the heat source side, and ends at the other side of the thermoelectric materials are in contact with the cold source side . . .

Insulators 32 are respectively arranged between the thermoelectric conversion module 3 and the heat source side, and between the thermoelectric conversion module 3 and the cold source side.

### Principle Description

The thermoelectric conversion module 3 realizes thermoelectric power generation. Thermoelectric power generation refers to the phenomenon that when there is a temperature difference between two ends of different thermoelectric materials 31, electromotance will be generated at both ends of the material to form a current, thereby achieving direct conversion of thermal energy into electrical energy. As shown in FIG. 1, P-type material and N-type material are two different types of semiconductor thermoelectric materials 31 (P-type material is a hole-rich material, and N-type material is an electron-rich material). Ends at one side of the thermoelectric materials are connected to form a PN junction and placed in a high-temperature heat source state; ends at the the other side form a low-temperature cold end; in the loop they form, if there is a temperature difference (Th, Tc) between the two contact points, under the action of thermal excitation, an electromotance is formed in the closed loop formed by the P-type material and N-type material, and heat current is generated. The thermoelectric material 31 completes the process of directly converting the thermal energy input from the high-temperature end into electrical energy. This phenomenon is called Seebeck effect, also known as the first thermoelectric effect. The temperature difference electromotance can be calculated by ε=α(Th−Tc). In the above formula: ε is the electromotance; Th is the hot end temperature; Tc is the cold end temperature; α is the relative Seebeck coefficient.

### Embodiment 2

A vehicle, comprising a cooler, a fuel cell and the system for waste heat recovery of a fuel cell according to any one of claims 1-4;
the cold source side performs heat exchange with the cooler.

The cold source side comprises a cold source box 1 and pipelines, the cold source box 1 comprises a cold source fluid inlet 11 and a cold source fluid outlet 12, and the cold source fluid inlet 11 and the cold source fluid outlet 12 are respectively communicated with the cooler through the pipelines; there is cold source fluid in the cold source box.

The fuel cell comprises a cooling flow channel;
the heat source side comprises a heat source box 2 and pipelines, and the heat source box 2 comprises a heat source fluid inlet 21 and a heat source fluid outlet 22, and the heat source fluid inlet 21 and the heat source fluid outlet 22 communicate with both ends of the cooling flow channel of the fuel cell through the pipelines; there is heat source fluid in the heat source box 2.

The vehicle also comprises a controller, a temperature sensor, a first pump, and a second pump;
the controller is electrically connected to the temperature sensor, the first pump and the second pump;
the temperature sensor is arranged on the fuel cell;
the first pump drives heat exchange between the cold source side and the cooler;
the second pump drives heat exchange between the heat source side and the fuel cell.

The vehicle also comprises a storage battery, and the storage battery is electrically connected to the controller, the temperature sensor, the first pump, the second pump, and the thermoelectric conversion module 3;
the controller controls direction of current between the storage battery and the thermoelectric conversion module 3.

### Operation Process

When the fuel cell is in operation, the high-temperature hot fluid flowing out of the cooling flow channel of the fuel cell flows into the heat source box 2 through the heat source fluid inleent. The heat in the high-temperature fluid is transferred to the thermoelectric conversion module through the insulation sheet, causing the hot end temperature of thermoelectric conversion module 3 converge with the temperature of the high-temperature hot fluid. After the heat is transferred by the heat source box 2, the high-temperature fluid flows out of the heat source fluid outlet 22 and enters the cooling flow channel of the fuel cell of the original loop for heating; similarly, the cooler/heat dissipation module is installed at the front end of the vehicle where it hits the wind or other low-temperature places. The cold source fluid flows into the cold source box 1 through the cold source fluid inlet, and absorbs the heat from the cold end of the thermoelectric conversion module 3 in the cold source, so that its temperature converges with the temperature of the cold source. Accordingly, the temperature difference between the hot and cold ends of the thermoelectric conversion module 3 is realized, thereby achieving the thermoelectric conversion effect. The generated current is introduced into the DCDC inverter 4 through the wiring harness for rectification to meet the current and voltage requirements of the electrical appliances. The rectified current is output through the output port 5 to complete the operation process of the entire device.

In summary, the present disclosure utilizes the temperature difference between the internal heat source of the fuel cell and the cold source such as the environment. When using a low-temperature proton exchange membrane fuel cell, the temperature difference between the hot end and cold end can reach 40-100° C.; and when using high-temperature protons exchange membrane fuel cells or solid oxide fuel cells, the temperature difference can even reach hundreds of degrees. This temperature difference can be used to generate corresponding thermoelectric electromotance at two ends of the thermoelectric material, thereby generating current to supply the corresponding electrical appliances. On the one hand, a large amount of waste heat is recovered instead of dissipating directly into the atmosphere, which improves the operating efficiency of the fuel cell system; on the other hand, it provides an additional source of power for electrical appliances, reducing the consumption of fuel cell output power, achieving energy saving effect.

2. Directly use the high-temperature coolant flowing out of the fuel cell stack and the low-temperature coolant flowing out of the heat dissipation module as heat and cold sources. There is no need to make adaptive improvements to the existing system. This device can be directly connected to the cooling circuit of the existing fuel cell system for use, which is convenient, fast and low-cost.

3. The method and device can be applied to fuel cell vehicles and other fuel cell systems. It is not only suitable for low-temperature fuel cell systems (LT-PEMFC, HT-PEMFC, etc.), but also for high-temperature fuel cell systems (SOFC, etc.). The higher the operating temperature of the fuel cell, the higher the electrical energy converted by this method and device. Many; it can even be applied to the power battery cooling circuit of pure electric vehicles for heat recovery, which has strong universal applicability.

4. Integrating the stack heating function into the thermoelectric material reduces the need for PTC components. At the same time, direct heating of the stack can also make the stack temperature rise faster and improve the cold start performance of the system.

The above are only embodiments of the present disclosure, and do not limit the patent scope of the present disclosure. Any equivalent transformations made using the contents of the description and drawings of the present disclosure, or directly or indirectly applied in related technical fields, are equally included in within the scope of patent protection of this disclosure.

1. A system for waste heat recovery of a fuel cell,
comprising a cold source side, a heat source side, and a thermoelectric conversion module located between the cold source side and the heat source side;
the fuel cell forms heat exchange with the heat source side;
when temperature of the fuel cell is greater than a preset value, the thermoelectric conversion module converts thermal energy into electrical energy;
when the temperature of the fuel cell is lower than the preset value, the thermoelectric conversion module is reversely electrified to heat the heat source side.

2. The system for waste heat recovery of a fuel cell according to claim 1, wherein the thermoelectric conversion module outputs through a DCDC inverter.

3. The system for waste heat recovery of a fuel cell according to claim 1, wherein the thermoelectric conversion module includes multiple groups of thermoelectric materials connected in series, ends at one side of the thermoelectric materials are connected by conductor to form a PN junction and are in contact with the heat source side, and ends at the other side of the thermoelectric materials are in contact with the cold source side.

4. The system for waste heat recovery of a fuel cell according to claim 1, wherein insulators are respectively arranged between the thermoelectric conversion module and the heat source side, and between the thermoelectric conversion module and the cold source side.

5. A vehicle, comprising a cooler, a fuel cell and the system for waste heat recovery of a fuel cell according to claim 1;
the cold source side performs heat exchange with the cooler.

6. The vehicle according to claim 5, wherein the cold source side comprises a cold source box and pipelines, the cold source box comprises a cold source fluid inlet and a cold source fluid outlet, and the cold source fluid inlet and the cold source fluid outlet are respectively communicated with the cooler through the pipelines; there is cold source fluid in the cold source box.

7. The vehicle according to claim 5, wherein the fuel cell comprises a cooling flow channel;
the heat source side comprises a heat source box and pipelines, and the heat source box comprises a heat source fluid inlet and a heat source fluid outlet, and the heat source fluid inlet and the heat source fluid outlet communicate with both ends of the cooling flow channel of the fuel cell through the pipelines; there is heat source fluid in the heat source box.

8. The vehicle according to claim 5, wherein the vehicle also comprises a controller, a temperature sensor, a first pump, and a second pump;
the controller is electrically connected to the temperature sensor, the first pump and the second pump;
the temperature sensor is arranged on the fuel cell;
the first pump drives heat exchange between the cold source side and the cooler;
the second pump drives heat exchange between the heat source side and the fuel cell.

9. The vehicle according to claim 8, wherein the vehicle also comprises a storage battery, and the storage battery is electrically connected to the controller, the temperature sensor, the first pump, the second pump, and the thermoelectric conversion module;
the controller controls direction of current between the storage battery and the thermoelectric conversion module.
